(19) United States
(12) Patent Application Publication
(10) Pub. No.: US 2014/0031481 A1
(43) Pub. Date: Jan. 30, 2014

(54) Polyamide compositions and article manufactured therefrom

(71) Applicants: Nancy J. Singletary, Alpharetta, GA (US); Corinne Bushelman, Cumming, GA (US); Linda M. Norfolk, Cumming, GA (US); Suresh R. Sriram, Alpharetta, GA (US); Christie W. Crowe, Alpharetta, GA (US)

(72) Inventors: Nancy J. Singletary, Alpharetta, GA (US); Corinne Bushelman, Cumming, GA (US); Linda M. Norfolk, Cumming, GA (US); Suresh R. Sriram, Alpharetta, GA (US); Christie W. Crowe, Alpharetta, GA (US)

(73) Assignee: SOLVAY SPECIALITY POLYMERS USA, LLC, Alpharetta, GA (US)

(21) Appl. No.: 14/009,579

(22) PCT Filed: Apr. 4, 2012
(86) PCT No.: PCT/EP2012/056140

§ 371 Date: Oct. 3, 2013

Related U.S. Application Data
(60) Provisional application No. 61/472,304, filed on Apr. 6, 2011.

(51) Int. Cl. C08K 3/34; C08K 3/22

(52) U.S. Cl. CPC C08K 3/34; C08K 3/22
USPC 524/456

(57) ABSTRACT

Polyamide composition very well suited for the manufacture of LED devices comprising: (a) at least a polyamide comprising recurring units derived from at least one C6 and/or at least one C10 diamine and from at least one dicarboxylic acid of the formula HO—C(═O)—R—C(═O)—OH wherein R is a cycloaliphatic moiety; (b) at least a reinforcing filler, and (c) at least a white pigment selected from a group consisting of TiO₂, ZnS₂, ZnO and BaSO₄.

This application claims priority to U.S. provisional application No. 61/472,304 filed Apr. 6, 2011, the whole content of this application being incorporated herein by reference for all purposes.

### FIELD OF INVENTION

The invention relates to a polyamide composition comprising at least a polyamide having a —C(═O)—R—C(═O)— moiety wherein R is a cycloaliphatic moiety.

The present invention further provides an article comprising the composition of the invention, such as LED devices.

### BACKGROUND OF THE INVENTION

Light emitting diode (LED) components, such as reflectors, reflector cups, and scramblers require an especially demanding combination of excellent color and improved physical properties. Ceramics may be advantageously used in those applications, but are still extremely costly. Therefore, polymer compositions have been extensively studied and developed to replace ceramics as a lower cost material. LED applications require polymer compositions with good opacity and reflective properties. Various useful polymer compositions for LED applications are known, these ones usually include polycondensation polymers, such as polyphthalamides. One problem noted with the prior art compositions used in LED applications is that they tend to yellow when exposed to light and heat.

LED components are exposed to elevated temperatures during the manufacturing process. For example, during the fabricating steps the LED components are heated to about 180° C. to cure an epoxy potting compound. The LED components are also exposed to temperatures above 260° C. while soldering operations are performed. In addition, while in use, LED components, such as automobile components, are routinely subjected to temperatures above 80° C. This exposure to high temperatures causes yellowing of polymer compositions used for forming LED components.

Desirably, reflector plates of LEDs and, in fine, the polymer composition from which they are made should comply with a wide set of requirements, including, notably, high reflectance of light (in general, of visible light), high whiteness, good processability (e.g. good moldability), high dimensional stability (notably low coefficient of linear expansion), high mechanical strength, high heat deflection temperature and high heat resistance (low discoloration and low loss of reflectance when exposed to a high temperature e.g. by means of soldering and the like).

Deterioration of components of reflectors may cause the LED devices to suffer from light distortion and/or poor emission efficiency after exposure to high temperature and high intensity radiation.

Compounds of high melting polyamides containing terephthalic acid show utility as materials for the reflector plates/reflecting surfaces of lighting devices based upon LEDs. The resin compounds, which typically contain titanium dioxide pigment, exhibit superior properties for molding and the molded parts exhibit high thermal stability, including dimensional stability and retention of mechanical properties, during fabrication and end use. Retention of whiteness and reflectivity during processing and end use is also quite good.

U.S. Pat. No. 7,009,029 proposes a resin composition comprising a polyamide, titanium dioxide and inorganic filler for withstanding the heat requirements of the Surface Mount Technology process typical in the manufacture of LED devices. The polyamide proposed comprises diamine and dicarboxylic acid units where at least 60 mol. % of the diacid is terephthalic acid and where at least 60 mol. % of the diamine comprises 1,9-nonanediamine and/or 2-methyl-1,8-octanediamine. Improved solder resistance and retention of reflectivity after heat aging at 170° C. and after UV exposure are claimed.

U.S. Pat. No. 6,936,682 discloses a composition of polyamide which exhibits good moldability, toughness, low water absorption, chemical resistance and excellent retention of strength after UV irradiation. These compositions find use in automotive, electric/electronic parts, industrial materials, etc. The polyamide composition comprises 10-80 mol. % in total carboxylic acid components of 1,4-cyclohexanedicarboxylic acid and an aliphatic diamine component (hexamethylene diamine). The disclosed compositions feature a lack of reflectivity retention.

JP 2011021128 relates to a polyamide composition suitable for LED reflector comprising 100 parts per weight of a polyamide made of cyclohexane dicarboxylic acid as the diacid and 1,9-nonanediamine and/or 2-methyl-1,8-diamine, 1-40 parts per weight of titanium oxide and 5-30 parts per weight of a reinforcement filler.

One of ordinary skill in the art will recognize that further improvements in heat stability, molding performance and reflectivity are advantageous for the development of LED assemblies. The utility of LED lighting devices of increasing power and brightness in electronics, in signage, in automobiles and in residential and commercial lighting has driven manufacturing and end use criteria to include even higher initial and retained reflectivity, while maintaining the production costs of the LED devices and a fortiori the costs of the materials made there from at an acceptable level.

### SUMMARY

The present invention relates to a composition comprising:
at least one polyamide comprising recurring units derived from at least one C6 and/or at least one C10 diamine and from at least one dicarboxylic acid of the formula HO—C(═O)—R—C(═O)—OH wherein R is a cycloaliphatic moiety;
at least one reinforcing filler; and
at least one white pigment selected from the group consisting of TiO₂, ZnS₂, ZnO and BaSO₄.

The composition of the present invention provides improved retention of reflectivity through the LED assembly manufacturing process that offers high reflectivity in the molded part with high in-use retention of whiteness and reflectivity. The composition further provides high moldability, solder resistance, adhesion and mechanical properties, and finds advantageous application when used in emission apparatus, such as LED devices.

These and other features, aspects, and advantages of the present subject matter will become better understood with reference to the following description.

### DETAILED DESCRIPTION

In a first aspect, the present invention provides a composition comprising:
at least one polyamide comprising recurring units derived from at least one C6 and/or at least one C10 diamine and from at least one dicarboxylic acid (A) of the formula HO—C(═O)—R—C(═O)—OH wherein R is a cycloaliphatic moiety;
at least one reinforcing filler; and
at least one white pigment selected from the group consisting of TiO₂, ZnS₂, ZnO and BaSO₄.

In a second aspect, the present invention provides an article, and in particular a LED, comprising at least one component comprising the polyamide composition according to the present invention.

In a third aspect, the present invention is related to the use of the composition according to the present invention in a light emission apparatus, and in particular in a LED.

### The Polyamide

Typically, the term “polyamide” is understood as being the polymer formed by reacting a mixture comprising at least one diamine and at least one dicarboxylic acid monomer units, and/or by polymerizing an amino carboxylic acid or lactam. The polyamide of the composition according to the present invention may be both aromatic and aliphatic.

The polyamide of the composition according to the present invention comprises recurring units derived from at least one C6 and/or at least one C10 diamine and from at least one dicarboxylic acid (A) of the formula HO—C(═O)—R—C(═O)—OH wherein R is a cycloaliphatic moiety. A cycloaliphatic moiety is intended to denote any organic moiety comprising at least one cycloaliphatic group.

The cycloaliphatic moiety can be a cis isomer or a trans isomer or mixtures thereof. All possible cis-trans isomer ratios of the cycloaliphatic moiety in the polyamide are encompassed in the present invention. In an embodiment of the present invention the cycloaliphatic moiety is a cis isomer, a trans isomer or a mixture thereof.

The dicarboxylic acid (A) may comprise from 5 to 30 carbon atoms. It comprises preferably from 8 to 14 carbon atoms, more preferably from 8 to 12. Non limitative examples of such dicarboxylic acid are listed below:

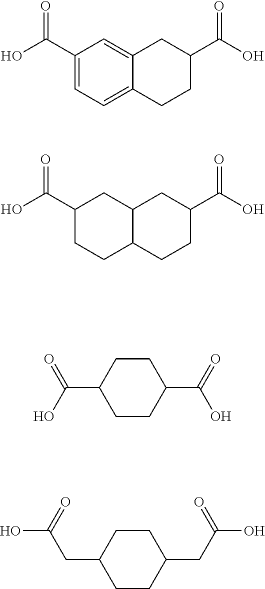 [SMILES: O=C(O)c1ccc2c(c1)CC(C(=O)O)CC2 ; O=C(O)C1CCC2CCC(C(=O)O)CC2C1 ; O=C(O)C1CCC(C(=O)O)CC1 ; O=C(O)CC1CCC(CC(=O)O)CC1]

The dicarboxylic acid (A) comprises preferably a cyclohexanedimethylene moiety or a cyclohexyl moiety, i.e. a 1,2-cyclohexyl or a 1,4-cyclohexyl moiety as the R moiety. Excellent results were obtained when the aliphatic dicarboxylic acid was selected from the group consisting of:

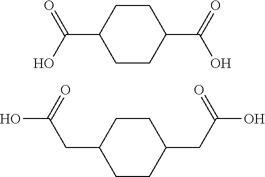

If aromatic recurring units are present, their aromaticity can come from the dicarboxylic acid(s) and/or from the diamine(s). For the purpose of the present invention, a dicarboxylic acid (or derivative thereof) or a diamine is considered as “aromatic” when it comprises one or more than one aromatic group.

In addition to the at least one dicarboxylic acid (A) of the formula HO—C(═O)—R—C(═O)—OH wherein R is a cycloaliphatic moiety, other dicarboxylic acids, named here after dicarboxylic acids (B), may be used for the manufacture of the polyamide of the composition according to the present invention. In such a case, the polyamide of the composition according to the present invention further comprises recurring units derived from at least one C6 and/or at least one C10 diamine and at least one dicarboxylic acid (B), different from the dicarboxylic acid (A). Those dicarboxylic acids (B) may be aromatic or aliphatic.

Non limitative examples of aromatic dicarboxylic acids (B) are notably phthalic acids, including isophthalic acid, terephthalic acid and orthophthalic acid, naphtalenedicarboxylic acids, 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene.

On the other hand, oxalic acid (HOOC—COOH), malonic acid (HOOC—CH₂—COOH), succinic acid [HOOC—(CH₂)₂—COOH], glutaric acid [HOOC—(CH₂)₃—COOH], 2,2-dimethyl-glutaric acid [HOOC—C(CH₃)₂—(CH₂)₂—COOH], adipic acid [HOOC—(CH₂)₄—COOH], 2,4,4-trimethyl-adipic acid [HOOC—CH(CH₃)—CH₂—C(CH₃)₂—CH₂—COOH], pimelic acid [HOOC—(CH₂)₅—COOH], suberic acid [HOOC—(CH₂)₆—COOH], azelaic acid [HOOC—(CH₂)₇—COOH], sebacic acid [HOOC—(CH₂)₈—COOH], undecanedioic acid [HOOC—(CH₂)₉—COOH], dodecandioic acid [HOOC—(CH₂)₁₀—COOH], tetradecandioic acid [HOOC—(CH₂)₁₁—COOH] are non limitative examples of aliphatic dicarboxylic acids (B).

The aliphatic dicarboxylic acids (B) can be linear or branched. They are preferably linear.

Dicarboxylic acids (A) and (B) may be replaced by acid halogenides, especially chlorides, acid anhydrides, acid salts, acid amides and the like, which can be advantageously used in the polycondensation reaction.

The polyamide of the composition according to the present invention is preferably formed by reacting in addition to at least one dicarboxylic acid (A) of the formula HO—C(═O)—R—C(═O)—OH wherein R is a cycloaliphatic moiety, a mixture comprising at least one dicarboxylic acid (B) is selected from the group consisting of isophthalic acid, terephthalic acid, naphtalenedicarboxylic acid, sebacic acid, adipic acid and mixtures thereof. More preferably, the mixture comprises isophthalic acid, terephthalic acid and optionally sebacic acid. In such a case, the polyamide of the composition according to the present invention further comprises, in addition to recurring units derived from at least one C6 and/or at least one C10 diamine and from at least one dicarboxylic acid (A) of the formula HO—C(═O)—R—C(═O)—OH wherein R is a cycloaliphatic moiety, other recurring units recurring units derived from at least one C6 and/or at least one C10 diamine and at least one dicarboxylic acid (B) selected from the group consisting of isophthalic acid, terephthalic acid, naphtalenedicarboxylic, sebacic acid, adipic acid and mixtures thereof.

When the polyamide of the composition according to the present invention is formed by reacting a mixture comprising at least one dicarboxylic acid (A) and at least one dicarboxylic acid (B), the amount of the at least one dicarboxylic acid (A) is preferably of less than 40 mol. %, more preferably less than 30 mol. %, still more preferably less than 25 mol. % and most preferably less than 20 mol. % based on the total amount of the dicarboxylic acid (A) and the dicarboxylic acid (B). The amount of the at least one dicarboxylic acid (A) is preferably of more than 2 mol. %, more preferably more than 4 mol. %, still more preferably more than 6 mol. % and most preferably more than 8 mol. % based on the total amount of the dicarboxylic acid (A) and the dicarboxylic acid (B).

In a preferred embodiment, the polyamide of the composition according to the present invention is formed by reacting a mixture comprising less than 20 mol. % of adipic acid, based on the total amount of dicarboxylic acid. Preferably, it is formed by reacting a mixture comprising less than 10 mol. %, more preferably less than 5 mol. % of adipic acid, based on the total amount of dicarboxylic acid. Most preferably, it is formed by reacting a mixture essentially free or even completely free of adipic acid.

The polyamide of the composition according to the present invention is manufactured by the polycondensation of at least one C6 and/or at least one C10 diamine.

Preferably, the C6 diamine is 1,6-hexanediamine or hexamethylenediamine (HMDA).

Preferably, the C10 diamine is 1,10-diaminodecane.

In addition to the at least one C6 and/or at least one C10 diamine, other diamines may also be used for the manufacture of the polyamide of the composition according to the present invention. Those diamines may also be aromatic or aliphatic.

Meta-phenylene diamine, meta-xylylene diamine and para-xylylene diamine are examples of aromatic diamine monomers.

On the other hand, non limiting example of aliphatic diamine are notably 1,2-diaminoethane, 1,2-diaminopropane, propylene-1,3-diamine, 1,3-diaminobutane, 1,4-diaminobutane, 1,5-diaminopentane, 1,8-diaminooctane, 1,9-nonanediamine, 1,12-diaminododecane, 1-amino-3-N-methyl-N-(3-aminopropyl)-aminopropane. The aliphatic diamines can be linear or branched. They are preferably linear. The aliphatic diamine is preferably selected from the group consisting of 1,4-diaminobutane, 1,5-diaminopentane, 1,8-diaminooctane, 1,9-nonanediamine, 1,11-undecanediamine and 1,12-diaminododecane.

In addition to the at least one C6 and/or at least one C10 diamine, the polyamide of the composition according to the present invention is preferably formed by reacting a mixture comprising at least one diamine selected from 1,8-diaminooctane, 1,12-diaminododecane or mixtures thereof.

The polyamide of the composition according to the present invention may also be formed by reacting a mixture comprising other monomer units than the above mentioned diamines and dicarboxylic acids (A) and (B). Diols are examples of such other monomer unit, in particular one can refer to 1,4-cyclohexanedimethanol.

The polyamide of the present invention is preferably a polyphthalamide (PPA).

For the purpose of the present description, the term “polyphthalamides” should be understood as defining any polymer of which at least 35 mol. %, preferably at least 50 mol. % of the recurring units are formed by the polycondensation reaction between at least one phthalic acid and at least one diamine. Phthalic acid includes any one of ortho-phthalic acid, isophthalic acid, terephthalic acid, and mixtures thereof.

According to the present invention, the polyphthalamide is preferably a polyterephthalamide.

For the purpose of the present description, the term “polyterephthalamide” should be understood as defining any polymer of which at least 35 mol. % of the recurring units, preferably at least 50 mol. % of the recurring units, based on the total number of moles of recurring units, are formed by the polycondensation reaction between at least terephthalic acid with at least one aliphatic diamine.

A first group of preferred polyterephthalamides are polyterephthalamides consisting essentially of recurring units formed by the polycondensation reaction between terephthalic acid, isophthalic acid, 1,4-cyclohexane dicarboxylic acid and hexamethylene diamine.

A second group of preferred polyterephthalamides are polyterephthalamides consisting essentially of recurring units formed by the polycondensation reaction between terephthalic acid, isophthalic acid, 1,4-cyclohexane dicarboxylic acid, 1,10-diaminodecane and hexamethylene diamine.

A third group of preferred polyterephthalamides are polyterephthalamides consisting essentially of recurring units formed by the polycondensation reaction between terephthalic acid, isophthalic acid, 1,4-cyclohexane dicarboxylic acid, 1,10-diaminodecane.

Advantageously, the terephthalic acid monomer and the aliphatic dicarboxylic acid monomer may be used together as a mixture in a mole ratio terephthalic acid/aliphatic dicarboxylic acid comprised between 8/1 and 0.5/1, preferably between 7/1 and 5/1.

In a particular embodiment, the present invention provides thus a composition comprising a polyterephthalamide formed by the polycondensation reaction between terephthalic acid, optionally isophthalic acid, cyclohexane dicarboxylic acid and hexamethylene diamine. In such a case, terephthalic acid is advantageously present in about 55-85 mol. %, preferably in about 60-80 mol. % and most preferably in about 65 mol. %, isophthalic acid is advantageously present in about 0-40 mol. %, preferably in about 15-35 mol. % and most preferably in about 15-35 mol. %, cyclohexane dicarboxylic acid is advantageously present in about 5-20 mol. %, preferably in about 10-20 mol. % and most preferably in about 20 mol. %, based on the total amount of dicarboxylic acid.

In another particular embodiment, the polyamide according to the present invention comprises also sebacic acid, in addition to terephthalic acid, optionally isophthalic acid, cyclohexane dicarboxylic acid and hexamethylene diamine. In such a case, terephthalic acid is advantageously present in about 55-85 mol. %, preferably in about 60-80 mol. % and most preferably in about 65 mol. %, isophthalic acid is advantageously present in about 0-40 mol %, preferably in about 15-35 mol. % and most preferably in about 15-35 mol. %, cyclohexane dicarboxylic acid is advantageously present in about 5-20 mol. %, preferably in about 10-20 mol. % and most preferably in about 20 mol. %, sebacic acid is advantageously present in about 1-30 mol. %, preferably in about 5-20 mol. % and most preferably in about 10-15 mol. %, based on the total amount of dicarboxylic acid.

The polyamide of the composition according to the present invention may also be endcapped by any end capping agent. The end-capping agent reacts with the ends of a polycondensate, capping the ends and limiting polymer molecular weight. The end capping agent is typically either a monofunctional carboxylic acid or carboxylic acid salt or a monofunctional aliphatic or alicyclic amine. Non limitative examples of such end capping agents include acetic acid, propionic acid, butyric acid, valeric acid, caproic acid, caprylic acid, lauric acid, stearic acid, cyclohexanecarboxylic acid, benzoic acid, methylamine, ethylamine, propylamine, butylamine, hexylamine, dimethylamine, cyclohexylamine, aniline, toluidine, etc. The end capping agent used for the manufacture of the polyamide of the composition according to the present invention is preferably acetic acid or benzoic acid. The end-capping agent is generally used in an amount of 0.1-6 moles, more preferably 0.5-4 moles, per 100 moles of the multifunctional carboxylic acid. By adjusting the amount of the end-capping agent, the intrinsic viscosity [η] of the resultant polyamide can be adjusted to optimize important process and product attributes in ways that are known to those skilled in the art.

Of course, more than one polyamide may be used in the composition in accordance with the invention.

The weight percent of the polyamide in the total weight of the composition is generally of at least 30 wt. %, preferably of at least 40 wt. %, and more preferably of at least 50 wt. %. Besides, the weight percent of the polyamide in the total weight of the polymer composition is generally of at most 90 wt. %, preferably of at most 80 wt. % and most preferably of at most 60 wt. %.

Excellent results were obtained when the polyamide was used in an amount of 40-70 wt. %, preferably of 50-60 wt. %, based on the total weight of the composition.

### The Reinforcing Filler

Reinforcing fillers are well known by the skilled in the art. The reinforcing filler of the composition in accordance with the present invention is preferably selected from fibrous and particulate fillers. More preferably, the reinforcing filler is selected from mineral fillers (such as talc, mica, kaolin, calcium carbonate, calcium silicate, magnesium carbonate), glass fiber, carbon fibers, synthetic polymeric fiber, aramid fiber, aluminum fiber, titanium fiber, magnesium fiber, boron carbide fibers, rock wool fiber, steel fiber, wollastonite etc. Still more preferably, it is selected from mica, kaolin, calcium silicate, magnesium carbonate, glass fiber and wollastonite etc.

A particular class of fibrous fillers consists of whiskers, i.e. single crystal fibers made from various raw materials, such as Al₂O₃, SiC, BC, Fe and Ni. Among fibrous fillers, glass fibers are preferred; they include chopped strand A-, E-, C-, D-, S- and R-glass fibers, as described in chapter 5.2.3, p. 43-48 of Additives for Plastics Handbook, 2nd edition, John Murphy, the whole content of which is herein incorporated by reference. Preferably, the filler is chosen from fibrous fillers.

In a preferred embodiment of the present invention the reinforcing filler is chosen from wollastonite and glass fiber. Excellent results were obtained when wollastonite and/or glass fibers were used. Glass fibers may have a round cross-section or a non-circular cross-section.

The weight percent of the reinforcing filler in the total weight of the composition (P) is generally of at least 5 wt. %, preferably of at least 10 wt. %, more preferably of at least 15 wt. % and most preferably of at least 20 wt. %. Besides, the weight percent of the reinforcing filler in the total weight of the polymer composition is generally of at most 50 wt. %, preferably of at most 40 wt. % and most preferably of at most 30 wt. %.

Excellent results were obtained when the reinforcing filler was used in an amount of 10-40 wt. %, preferably of 20-30 wt. %, based on the total weight of the composition.

### The White Pigment

White pigments are typically characterized by the fact that their light-absorption is very small compared with their light scattering. Otherwise stated, these pigments absorb typically essentially no light in the visible region (wavelength 400-800 nm), but disperse incident radiation in this region as completely as possible. The white pigment in accordance with the present invention is selected from the group consisting of titanium dioxide (TiO₂), zinc disulfide (ZnS₂), zinc oxide (ZnO) and barium sulfate (BaSO₄).

The white pigment is advantageously in the form of particles having a weight-average size (equivalent diameter) preferably of below 5 μm. Larger sizes may deleteriously affect the properties of the composition. Preferably, the weight-average size of the particles is of below 1 μm. Besides, it is preferably above 0.1 μm.

The shape of the particles is not particularly limited; they may be notably round, flaky, flat and so on.

The white pigment is preferably titanium dioxide. The form of titanium dioxide is not particularly limited, and a variety of crystalline forms such as the anatase form, the rutile form and the monoclinic type can be used. However, the rutile form is preferred due its higher refraction index and its superior light stability. Titanium dioxide may be treated or not with a surface treatment agent. Preferably the average particle size of the titanium oxide is in the range of 0.15 μm to 0.35 μm.

The weight percent of the white pigment in the total weight of the composition is generally of at least 1 wt. %, preferably of at least 6 wt. %, more preferably of at least 8 wt. % and most preferably of at least 15 wt. %. Besides, the weight percent of the white pigment in the total weight of the polymer composition generally of at most 50 wt. %, preferably of at most 40 wt. %, more preferably of at most 30 wt. % and most preferably of at most 30 wt. %.

Excellent results were obtained when the white pigment was used in an amount of 10-30 wt. %, preferably of 15-25 wt. %, based on the total weight of the composition.

### Optional Ingredients

The composition in accordance with the invention can optionally comprise additional components such as stabilizing additive, notably mold release agents, plasticizers, lubricants, thermal stabilizers, light stabilizers and antioxidants etc.

The composition in another preferred embodiment further comprises at least a stabilizing additive. The stabilizing additive may be present in an amount of 1 to 10 wt. %.

The levels of these optional additives will be determined for the particular use envisioned, with generally up to 20 wt. %, preferably up to 10 wt. %, more preferably up to 5 wt. % and still more preferably up to 2 wt. % (based on the total weight of the polymer composition) of such additional additives considered to be within the range of ordinary practice in the extrusion art.

Certain stabilizers such as hindered amine light stabilizers (HALS) may be present in the composition. For example one or more of the group of hindered amines selected from the group bis(2,2,6,6-tetramethylpiperidin-4-yl)sebacate, bis(1,2,2,6,6-pentamethyl piperidin-4-yl)sebacate, di(1,2,2,6,6-pentamethylpiperidin-4-yl)(3,5-di-tert-butyl-4-hydroxybenzyl)butylmalonate, the polycondensation product of 1-(2-hydroxyethyl)-2,2,6,6-tetramethyl-4-hydroxypiperidine and succinic acid, the polycondensation product of 2,4-dichloro-6-tert-octylamino-s-triazine and 4,4′-hexamethylenebis(amino-2,2,6,6-tetramethylpiperidine), N,N′,N″,N′″-tetrakis[(4,6-bis(butyl-(1,2,2,6,6-pentamethylpiperidin-4-y-1)amino)-s-triazine-2-yl]-1,10-diamino-4,7-diazadecane, di-(1-octyloxy-2,2,6,6-tetramethylpiperidin-4-yl)sebacate, di-(1-cyclohexyloxy-2,2,6,6-tetramethylpiperidin-4-yl)succinate, 1-octyloxy-2,2,6,6-tetramethyl-4-hydroxypiperidine, poly-{[6-tert-octylamino-s-triazin-2,4-diyl][2-(1-cyclohexyloxy-2,2,6,6-tetramethylpiperidin-4-yl)imino-hexamethylene-[4-(1-cyclohexyloxy-2,2,6,6-tetramethylpiperidin-4-yl)imino], or 2,4,6-tris[N-(1-cyclohexyloxy-2,2,6,6-tetramethylpiperidin-4-yl)-n-butylamino]-s-triazine may be present in the composition according to the present invention.

The composition can additionally contain one or more other UV absorbers selected from the group consisting of s-triazines, oxanilides, hydroxybenzophenones, benzoates and α-cyanoacrylates.

Thermal stabilizers may also be included in the composition. The thermal stabilizers commonly used in polyamide compositions are well known in the art. They can typically be one or more selected from, 3,9-bis[1,1-dimethyl-2-[(3-tert-butyl-4-hydroxy-5-methylphenyl)propionyloxy]ethyl]-2,4,8,10-tetraoxaspiro[5.5]undecane, pentaerythritol tetrakis(3-(3,5-di-tert-butyl-4-hydroxyphenyl)propionate), 3,3′-bis(3,5-di-tert-butyl-4-hydroxyphenyl)-N,N′-hexamethylenedipropionamide, 1,3,5-tris(3,5-di-(tert)-butyl-4-hydroxybenzyl)-1,3,5-triazine-2,4,6(1H,3H,5H)-trione, 1,3,5-triazine-2,4,6(1H,3H,5H)-trione, 1,3,5-tris[[4-(1,1-dimethylethyl)-3-hydroxy-2,6-dimethylphenyl]methyl], benzenepropanoic acid, 3-(1,1-dimethylethyl)-b-[3-(1,1-dimethylethyl)-4-hydroxyphenyl]-4-hydroxy-b-methyl-, 1,1′-(1,2-ethanediyl)ester, bis(1,2,2,6,6-pentamethyl-4-piperidyl) [[3,5-bis(1,1-dimethylethyl)-4-hydroxyphenyl]methyl]butylmalonate, 2-(4,6-diphenyl-1,3,5-triazin-2-yl-)-5-((hexyl)oxyl-phenol, 2,4,8,10-tetraoxa-3,9-diphodphaspiro[5,5]undecane, 3,9-bis[2,6-bis-1,1-dimethylethyl]-4-methylphenoxy], 12H dibenzo[d,g][1,3,2]dioxaphosphocin, 2,4,8,10-tetrakis(1,1-dimethylethyl)-6-[(2-ethylhexyl)oxy], 2,4,8,10-tetraoxa-3,9-diphosphaspiro[5.5]undecane, 3,9-bis[2,4-bis(1-methyl-1-phenylethyl)phenoxy], tris(2,4-di-(tert)-butylphenyl)phosphate, bis-2,4-di-tert-butylphenyl)pentaerythritol diphosphite, 2,4,8,10-tetraoxa-3,9-diphosphaspiro[5.5]undecane, 3,9-bis(octadecyloxy), 2,4,8,10-tetraoxa-3,9-diphosphaspiro[5.5]undecane, 3,9-bis[2,4-bis(1-methyl-1-phenylethyl)phenoxy], 2-(tert-Butyl)-6-methyl-4-(3-((2,4,8,10-tetrakis(tert-butyl)dibenzo[d,f][1,3,2]dioxaphosphepin-6-yl)oxy)propyl)phenol and bis[4-(2-phenyl-2-propyl)phenyl]amine.

In a particular embodiment the composition does not contain any hindered amine light stabilizer, does not contain any thermal stabilizer, or does not contain any of a hindered amine light stabilizer and a thermal stabilizer.

### The Article

An aspect of the present invention also provides an article comprising at least one component comprising the polyamide composition of the present invention, which provides various advantages over prior art parts and articles, in particular an increased resistance to concurrent exposure to heat and UV rays while maintaining all their other properties at a high level. Preferably, the article or part of the article consists of the polymer composition.

In a particular embodiment, the article is a light emission apparatus.

Non limitative examples of light emission apparatuses are keyless entry systems of an automobile, lightings in a refrigerator, liquid crystal display apparatuses, automobile front panel lighting apparatuses, desk lamps, headlights, household electrical appliance indicators and outdoor display apparatuses such as traffic signs, and optoelectronic devices comprising at least one semi-conductor chip that emits and/or transmits electromagnetic radiation commonly known as Light Emitting Diodes devices (LEDs). Preferably, the light emission apparatus is a Light Emitting Diode device (LED).

LEDs are preferably chosen from the group of top view LEDs, side view LEDs and power LEDs. Top view and side view LEDs comprise usually a basic housing, which, in general, acts as reflector; besides, top view and side view LEDs usually do not comprise any heatsink slug. On the other hand, power LEDs comprise usually a heatsink slug, which, in general, acts as reflector; power LEDs usually further comprise a basic housing, which is a part distinct from the heatsink slug.

The top view LEDs are notably used in automotive lighting applications such as instrumental panel displays, stop lights and turn signals. The side view LEDs are notably used for mobile appliance applications such as, for example, cell phones and PDAs. The power LEDs are notably used in flashlights, automotive day light running lights, signs and as backlight for LCD displays and TVs.

The LED according to the present invention comprises at least one part comprising the polymer composition as above described. The part is preferably chosen from basic housings and heatsink slugs. The part acts usually as reflector.

Preferably at least 50 wt. % and more preferably more than 80 wt. % of the part comprises the polymer composition (the part can possibly further contain notably a metal; for example, for certain end uses, the surface of the part acting as reflector may be metal plated). More preferably, more than 90 wt. % of the part comprises the polymer composition. Still more preferably, the part consists essentially of the polymer composition. The most preferably, the part consists of the polymer composition.

Should the disclosure of any patents, patent applications, and publications which are incorporated herein by reference conflict with the description of the present application to the extent that it may render a term unclear, the present description shall take precedence.

### EXAMPLES

The disclosure will now be illustrated with working examples, which are intended to illustrate the working of disclosure and not intended to take restrictively to imply any limitations on the scope of the present disclosure.

The following commercially available materials were used:

### Wollastonite:

Vansil® HR-1500 available from RT Vanderbilt—9μ median particle size—14:1 aspect ratio (as specified by supplier)

Titanium Dioxide:

Pigment 1: Ti-Pure® R-105 available from DuPont Titanium Technologies—rutile TiO₂ manufactured by chloride process, treated with silica and alumina.

Pigment 2: Tipaque PC-3 available from Ishihara Sangyo Kaisha, Ltd—rutile TiO₂ manufactured by chloride process, treated with silica and alumina.

Preparation of Polyamide Resin a PA 6, T/6, I/6, CHDA with Repeat Unit Mole Ratio of Hexamethylene Terephthalamide, Hexamethylene Isophthalamide and Hexamethylene 1,4-Cyclohexamide of 65:25:10

A stirred batch vessel was charged with a diamine component consisting of 28,289 g of an aqueous solution of 1,6-hexanediamine containing 69.7 wt. % of said diamine (169.60 mol.) and with a dicarboxylic acid component consisting of 17,018 g of terephthalic acid (102.44 mol), 6,546 g of isophthalic acid (39.40 mol.) and 2,714 g of 1,4-cyclohexanedicarboxylic acid (15.76 mol.). The reactor was also charged with 54.3 g of sodium hypophosphite, 586 g of benzoic acid (4.8 mol.) and 14,450 g of distilled water. A salt solution was obtained by heating the above described mixture at 127° C. The contents were pumped continuously to a reactor zone maintained at about 165 psig and 221° C., then to a zone maintained at about 310° C. and 1800 psig, then through a tubular reactor at 100 psig and 332° C. and into a vented Werner and Pfleiderer Corporation ZSK-30® twin-screw extruder equipped with a forward vacuum vent. Die temperature was set at 325° C. The finished polymer was extruded through a strand die into a water bath at a through-put rate of about 5.5-6.5 kg/hr and then chopped into pellets. The melting point of the obtained polyamide, measured by DSC (according to ASTM D3418-2008), was 324° C.

Preparation of Polyamide B PA 6, T/6, I/6, CHDA with Repeat Unit Mole Ratio of Hexamethylene Terephthalamide, Hexamethylene Isophthalamide and Hexamethylene 1,4-Cyclohexamide of 65:25:10

Polyamide B was produced according to the procedure described above but using the ingredients in the following quantities: 25,460 g 69.7% aqueous hexamethylenediamine, 15,161 g terephthalic acid, 5,831 g isophthalic acid, 2,417 g 1,4-cyclohexanedicarboxylic acid, 879 g benzoic acid, 49.0 g sodium hypophosphite and 13,060 g distilled water. The melting point of Polymer B was 329° C.

Preparation of Polyamide Resin C PA 6, T/6, I (Comparative Resin) with Repeat Unit Mole Ratio of Hexamethylene Terephthalamide and Hexamethylene Isophthalamide of 70:30

Polyamide C was produced according to the procedure described above but using the ingredients in the following quantities: 28,289 g 69.7% aqueous hexamethylenediamine, 18,327 g terephthalic acid, 7,855 g isophthalic acid, 288 g glacial acetic acid, 53.8 g sodium hypophosphite and 14,255 g distilled water. The melting point of Polymer C was 327° C.

Preparation of Polyamide Resin D PA 6, T/6, 6 (Comparative Resin) with Repeat Unit Mole Ratio of Hexamethylene Terephthalamide and Hexamethylene Adipamide of 65:35

Polyamide D was produced according to the procedure described above but using the ingredients in the following quantities: 32.5 wt. % hexamethylenediamine, 27.0 wt. % terephthalic acid, 12.8 wt. % adipic acid, 0.46% acetic acid, 0.083 wt. % sodium hypophosphite and 27 wt. % distilled water. The melting point of Polymer D was 324° C.

### Preparation of Composition of Example 1

The polyamide resin A prepared according to the procedure described above was fed to the first barrel of a ZSK-26 twin screw extruder comprising 12 zones via a loss in weight feeder. The barrel settings were in the range of 280-330° C. and the resin was melted before barrel 5. The wollastonite and the TiO₂ powder (pigment 1) were fed at barrel 5 through a side stuffer via a loss in weight feeder. The screw rate was 250 rpm. The extrudate was cooled and pelletized using conventional equipment.

### Preparation of Composition of Example 2

The same procedure as the one described in example 1 was used, except that pigment 2 was used.

### Preparation of Composition of Example 3

The same procedure as the one described in example 2 was used, except that resin B was used.

### Preparation of Composition of Comparative Example 1

The same procedure as the one described in example 1 was used, except that resin C was used.

### Preparation of Composition of Comparative Example 2

The same procedure as the one described in comparative example 1 was used, except that pigment 2 was used.

### Preparation of Composition of Comparative Example 3

The same procedure as the one described in comparative example 1 was used, except that resin D was used.

### Preparation of Composition of Comparative Example 4

The same procedure as the one described in comparative example 2 was used, except that resin D was used.

Each one of the compositions of example 1-3 and comparative examples 1-4 were used to prepare discs of about 50 mm diameter with a thickness of about 1.6 mm.

The amount of each ingredient is given in weight % in Table 1. Percentage retention of reflectivity with discs as molded and when disc were heated in air at 260° C. for 10 min is also given in Table 1. Reflectivity was measured with a BKY-Gardner photo-spectrometer.

TABLE 1

| | | | | Comparative | Comparative | Comparative | Comparative |
|---|---|---|---|---|---|---|---|
| | Example 1 | Example 2 | Example 3 | example 1 | example 2 | example 3 | example 4 |
| Polyamide (%) | | | | | | | |
| resin A PA 6, T/6, I/6, CHDA | 58 | 58 | | | | | |
| resin B PA 6, T/6, I/6, CHDA | | | 58 | | | | |
| resin C PA 6, T/6, I | | | | 58 | 58 | | |
| resin D PA 6, T/6, 6 | | | | | | 58 | 58 |
| Reinforcing filler (%) | | | | | | | |
| Wollastonite | 22 | 22 | 22 | 22 | 22 | 22 | 22 |
| White pigment (%) | | | | | | | |
| Pigment 1 | 20 | | | 20 | | 20 | |
| Pigment 2 | | 20 | 20 | | 20 | | 20 |
| Reflectivity measurements at | | | | | | | |
| 450 nm (%) | | | | | | | |
| As molded | 91.8 | 90.6 | 90.3 | 92.2 | 91.2 | 90.0 | 90.6 |
| After 10 min at 260° C. | 68.5 | 72.7 | 74.2 | 52.4 | 55.5 | 49 | 51.6 |
| Difference | 23.3 | 17.9 | 16.1 | 39.8 | 35.7 | 41 | 39 |

The compositions of the present invention surprisingly show higher retention of reflectivity after exposure to air at 260° C. for 10 min compared to comparative polyamides.

The Applicant has found out that the incorporation of low amounts (as low as 10 mol. %) of dicarboxylic acid (A) comprising a cycloaliphatic moiety in the backbone of aromatic polyamides leads to the obtention of very high improvements in terms of reflectivity performance while maintaining all the other properties at the same level and while maintaining the manufacturing costs at an acceptable level.

1. A composition comprising:
at least one polyamide polymer comprising recurring units derived from at least one C6 diamine and/or at least one C10 diamine and from at least one dicarboxylic acid (A) of the formula HO—C(═O)—R—C(═O)—OH wherein R is a cycloaliphatic moiety;
at least one reinforcing filler; and
at least one white pigment selected from the group consisting of TiO₂, ZnS₂, ZnO, and BaSO₄.

2. The composition according to claim 1, wherein said reinforcing filler comprises wollastonite or glass fiber.

3. The composition according to claim 1, wherein said white pigment comprises TiO₂.

4. The composition according to claim 1, wherein the composition comprises, based on the total weight of the composition, at least 40 wt. % of the polyamide polymer.

5. The composition according to claim 1, wherein the composition comprises, based on the total weight of the composition is at least 15 wt. % of the reinforcing filler.

6. The composition according to claim 1, wherein the composition comprises, based on the total weight of the composition, at least 6 wt. % of the white pigment.

7. The composition according to claim 1, wherein the at least one polyamide polymer further comprises recurring units derived from at least one dicarboxylic acid (B), wherein the dicarboxylic acid (B) is different from the dicarboxylic acid (A).

8. The composition according to claim 7, wherein the at least one dicarboxylic acid (B) is selected from the group consisting of isophthalic acid, terephthalic acid, naphthalenedicarboxylic acid, sebacic acid, adipic acid, and mixtures thereof.

9. The composition according to claim 7, wherein the composition comprises, based on the total combined amount of dicarboxylic acid (A) and dicarboxylic acid (B), less than 40 mol. % of dicarboxylic acid (A).

10. The composition according to claim 1, wherein the at least one C6 diamine comprises hexamethylene diamine and the at least one dicarboxylic acid is selected from the group consisting of:

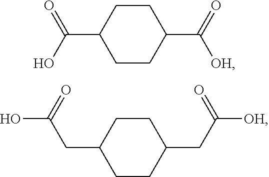

11. An article comprising at least one component comprising the composition according to claim 1.

12. The article of claim 11 wherein said article is a light emission apparatus.

13. The light emission apparatus according to claim 12, wherein said apparatus is a light emitting diode device.

14. The light emitting diode device according to claim 13, wherein it comprises a reflector comprising the composition according to claim 1.

15. (canceled)

16. A method for making a component of light emitting apparatus, comprising molding the composition of claim 1 to form the component.

17. The method of claim 16, wherein the light emitting apparatus is a light emitting diode device and the component is a basic housing or a heatsink slug.

18. A composition comprising, based on the total weight of the composition:
from 40 to 80 percent by weight of at least one polyamide polymer comprising recurring units derived from at least one C6 diamine, at least one dicarboxylic acid (A) of the formula HO—C(═O)—R—C(═O)—OH, wherein R is cyclohexane or cyclohexanedimethylene, and a carboxylic acid (B) selected from isophthalic acid, terephthalic acid, naphthalenedicarboxylic acid, sebacic acid, adipic acid, and mixtures thereof;
from 10 to 40 percent by weight of at least one reinforcing filler selected from wollastonite and glass fiber; and
from 10 to 30 percent by weight of at least one white pigment selected from the group consisting of TiO₂, ZnS₂, ZnO, and BaSO₄.

19. The composition of claim 18, wherein:
the at least one C6 diamine comprises hexamethylenediamine.

20. The composition of claim 18, wherein:
the carboxylic acid (A) comprises cyclohexane dicarboxylic acid,
the carboxylic acid (B) comprises isophthalic acid, terephthalic acid, or a mixture thereof,
the reinforcing fiber comprises wollastonite, and
the white pigment comprises TiO₂.
